(19) United States
(12) Patent Application Publication
(10) Pub. No.: US 2015/0251962 A1
(43) Pub. Date: Sep. 10, 2015

(54) FERTILIZER COMPOSITIONS CONTAINING MICRONUTRIENTS AND METHODS FOR PREPARING THE SAME

(71) Applicant: The Mosaic Company, Plymouth, MN (US)

(72) Inventors: Lawrence Alan Peacock, Riverview, FL (US); Ryan Johnston, Haines City, FL (US)

(21) Appl. No.: 14/640,762

(22) Filed: Mar. 6, 2015

Related U.S. Application Data
(60) Provisional application No. 61/949,740, filed on Mar. 7, 2014.

(51) Int. Cl. C05B 7/00; C05B 19/00

(52) U.S. Cl. CPC C05B 7/00; C05B 19/00

(57) ABSTRACT

A granulated fertilizer having a primary nutrient and a micronutrient and related methods of making. The micronutrient is incorporated into the fertilizer mixture by dissolving a compound form of the micronutrient into a feed stream for the formulation of the fertilizer material, a water return stream for the scrubbing of waste gas, and/or a feed stream for back titration of the fertilizer material.

### RELATED APPLICATION

The present application claims the benefit of U.S. Provisional Application No. 61/949,740 filed Mar. 7, 2014, which is incorporated herein in its entirety by reference.

### FIELD OF THE INVENTION

The present invention is generally directed to a granulated fertilizer incorporating micronutrients. Specifically, the present invention is directed to a granulated fertilizer in which the micronutrients are added to the fertilizer prior to and/or during the granulation of the fertilizer.

### BACKGROUND OF THE INVENTION

Many chemical elements, including both mineral and non-mineral elements, are important for a plant's growth and survival. The non-mineral elements can include, for example, hydrogen, oxygen, and carbon, typically available from the surrounding air and water. The mineral nutrients, including nitrogen, phosphorous, and potassium are available or made available in the soil for uptake by the plant's roots.

The mineral nutrients can generally be divided into two groups: macronutrients, including primary nutrients and secondary nutrients, and micronutrients. The primary mineral nutrients include nitrogen (N), phosphorous (P), and potassium (K). Large amounts of these nutrients are essential to a plant's survival, and therefore typically make up the majority of a fertilizer composition. In addition to primary nutrients, secondary nutrients are required in much smaller amounts than those of the primary nutrients. Secondary nutrients can include, for example, calcium (Ca), sulfur (S), and magnesium (Mg). Micronutrients can include, for example, boron (B), copper (Cu), iron (Fe), manganese (Mn), molybdenum (Mo), zinc (Zn), chlorine (Cl), cobalt (Co), sodium (Na), and combinations thereof.

Particular to micronutrients, micronutrient sources vary considerably in their physical state, chemical reactivity, cost, and availability to plants. The most common method of micronutrient application for crops is soil application. Recommended application rates usually are less than 10 lb/acre on an elemental basis so uniform application of micronutrient sources separately in the field can be difficult. Including micronutrients with mixed fertilizers is a convenient method of application and allows more uniform distribution with conventional application equipment. Costs also are reduced by eliminating a separate application step. Four methods of applying micronutrients with mixed fertilizers can include incorporation during manufacture, bulk blending with granular fertilizers, coating onto granular fertilizers, and mixing with fluid fertilizers.

Incorporation during manufacture is the incorporation of one or more micronutrients directly in fertilizers granules, such as NPK, urea, potash, or phosphate fertilizers, as they are being produced. This practice allows each granule of fertilizer to have a consistent concentration of the desired micronutrient(s) and uniform distribution of the micronutrient(s) throughout the granular fertilizers. Because the granules are evenly dispersed over the growing area, the contained micronutrient(s) are as well.

Bulk blending with granular fertilizers is the practice of bulk blending separately granulated secondary nutrients and/or micronutrient compounds with granular fertilizers, such as phosphate or potash fertilizers. The main advantage to this practice is that fertilizer grades can be produced which will provide the recommended micronutrient rates for a given field at the usual fertilizer application rates. The main disadvantage is that segregation of nutrients can occur during the blending operation and with subsequent handling. In order to reduce or prevent size segregation during handling and transport, the micronutrient granules must be close to the same size as the phosphate and potash granules. Because the micronutrients are required in very small amounts for plant nutrition, this practice has resulted in granules of micronutrients unevenly distributed and generally too far from most of the plants to be of immediate benefit as most migrate in soil solution only a few millimeters during an entire growing season.

Coating of granular fertilizers decreases the possibility of segregation. However, some binding materials are often times unsatisfactory because they do not maintain the micronutrient coatings during bagging, storage, and handling, which results in segregation of the micronutrient sources from the granular fertilizer components. Steps have been taken to reduce the segregation problem in the case secondary nutrients and micronutrients, for example as in the case of sulfur or sulfur platelets in the fertilizer portion as described in U.S. Pat. No. 6,544,313 entitled “Sulfur-Containing Fertilizer Composition and Method for Preparing Same” and in the case of micronutrients as described in U.S. Pat. No. 7,497,891 entitled, “Method for Producing a Fertilizer with Micronutrients,” both of which are incorporated herein by reference in their entireties.

There remains a need for a fertilizer product that contains one or more micronutrients that maximizes the introduction of the micronutrient(s) into soil solution and ultimately to the root zone of plants.

### SUMMARY OF THE INVENTION

Embodiments of the present invention are directed to a granulated fertilizer containing micronutrients, and related methods of making, having at least one primary nutrient and at least one source of a micronutrient. In an embodiment of the present invention, the micronutrient is dissolved into a feed or a process stream for a stage in the production or granulation of the fertilizer material. The micronutrient is incorporated as a non-reactant into the production of the fertilizer such that the micronutrient is evenly concentrated throughout the resulting fertilizer granules.

In one embodiment, the micronutrient is dissolved into a feed stream or scrubber water stream into the pre-neutralizer or reactor used in the formulation of the fertilizer material containing the primary nutrient to distribute the micronutrient throughout the fertilizer material prior to granulation. In another embodiment, the micronutrient can be dissolved into a feed stream, such as a feed acid stream, feeding into a rotating granulation drum for granulating formulated fertilizer material to apply the pre-nutrient to the fertilizer material during granulation. Unlike bulk mixing where the granulated fertilizer and micronutrient can be separated by size segregation, micronutrients incorporated or applied to the fertilizer material dissolved within a feed stream are less likely to separate from the granulated fertilizer during transport and handling.

A method of producing a fertilizer, according to an embodiment of the present invention, generally comprises formulating a quantity of a fertilizer material in a pre-neutralizer and/or a reactor. The method can also comprise granulating the fertilizer material within a rotating granulation drum. The method can further comprise drying the fertilizer granules and removing the fertilizer granules that do not fall within a predetermined range for reprocessing to the correct particle size.

In one embodiment, and in particular to the production of a phosphate fertilizer such as, for example, monoammonium phosphate (MAP) or diammonium phosphate (DAP), the method can further comprise dissolving a compound of one or more desired micronutrients within a phosacid feed stream into the pre-neutralizer or reactor. The micronutrient compound is a non-reactant component that does not affect the formulation of primary nutrient fertilizer; rather it is distributed throughout the formed fertilizer granule. In this configuration, the relative concentration of the micronutrient dissolved in the feed stream(s) can be adjusted to affect the resulting concentration of the micronutrient in the fertilizer.

In another embodiment, the method can further comprise dissolving a compound of one or more desired micronutrients into the scrubber water return stream to the pre-neutralizer or reactor. Similarly, the micronutrient compound is a non-reactant component that is distributed throughout the primary nutrient fertilizer during the formulation process. As with the micronutrients dissolved in the feed stream, the relative concentration of the micronutrient dissolved in the scrubber return stream can be adjusted to affect the resulting concentration of the micronutrient in the fertilizer.

In yet another embodiment, the method can further comprise adding a quantity of phosacid into the granulation drum during the granulation of the primary nutrient fertilizer for back-titration in MAP production (i.e. to reduce the N:P mole ratio), wherein a compound or source of one or more micronutrients is dissolved in this phosacid stream. The amount of micronutrient applied to the fertilizer granules is adjusted by changing the relative concentration of the micronutrient dissolved in this phosacid stream.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a schematic flow diagram of a system for producing granulated fertilizer according to an embodiment of the present invention.

FIG. 2 is a schematic flow diagram of a system for producing granulated fertilizer including scrubber sub-system according to an embodiment of the present invention.

FIG. 3 is a schematic flow diagram of a system for producing granulated fertilizer including phosacid stream into a granulation drum according to an embodiment of the present invention.

FIG. 4 is a solubility curve, showing the water solubility of ammonium phosphate at different temperatures for a varying molar ratio of nitrogen to phosphorous.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

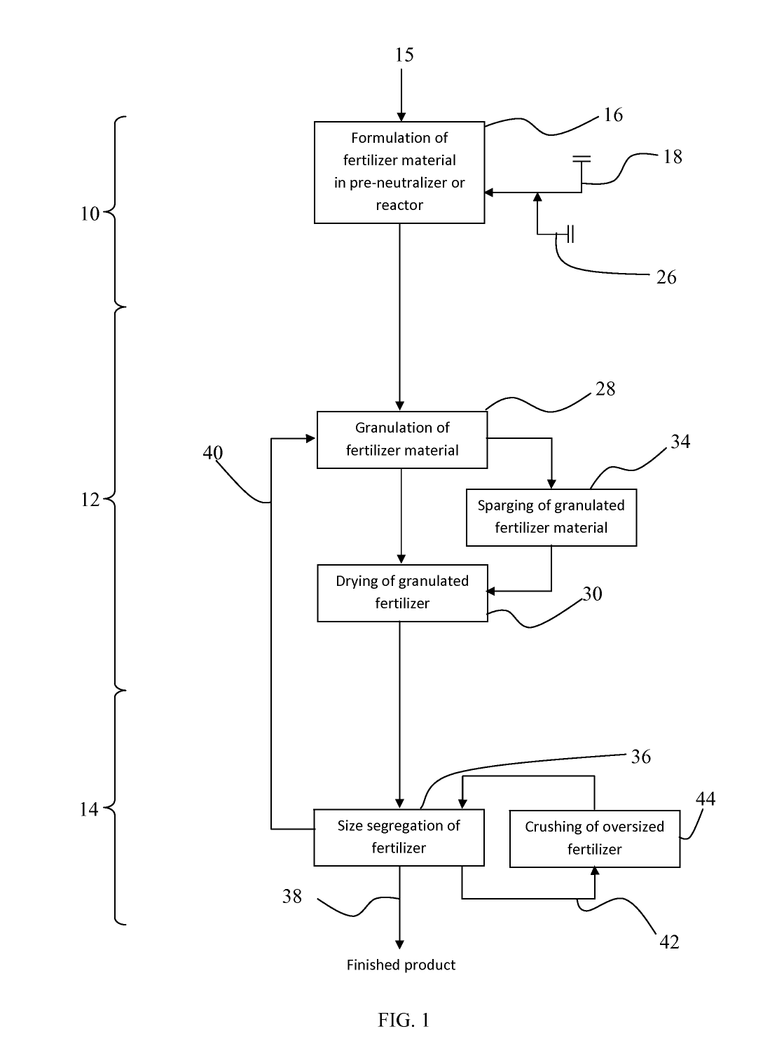

As shown in FIGS. 1-3, a method for producing a quantity of fertilizer granules, according to an embodiment of the present invention, generally comprises a slurry production stage 10, a granulation stage 12 and a size segregation/correction stage 14.

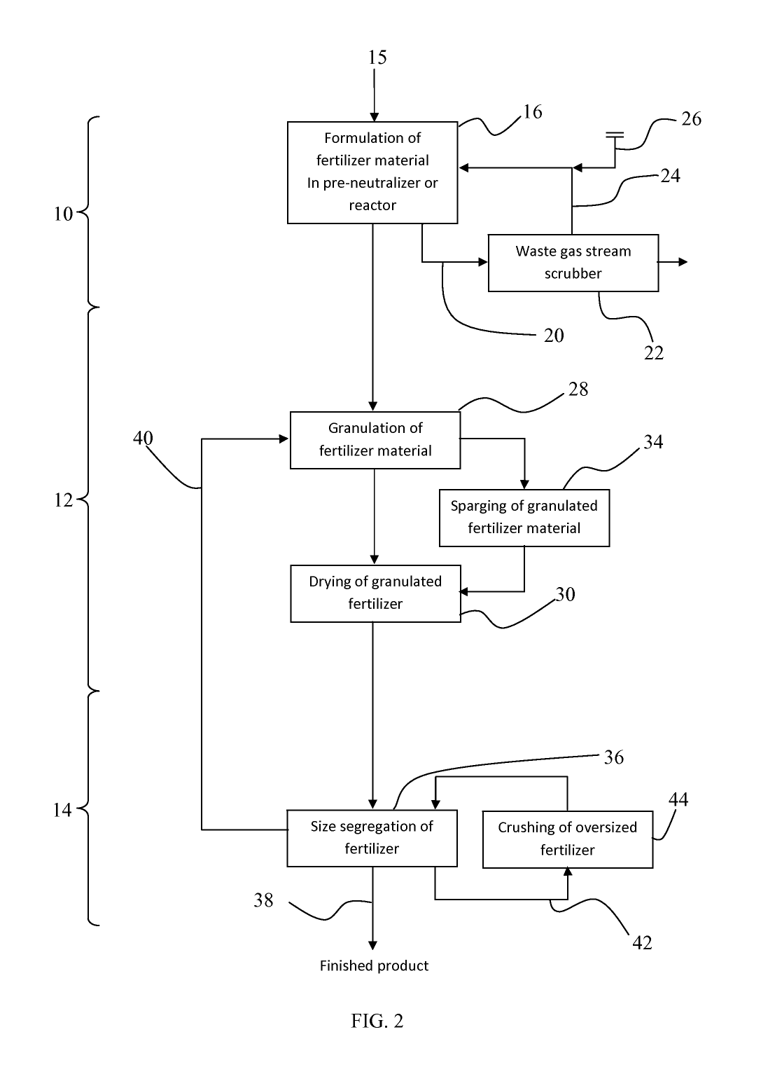

As shown in FIGS. 1-2, the slurry production stage 10 can comprise a formulation step 16 in which a quantity of fertilizer, such as, for example, a phosphate fertilizer or an ammonium phosphate fertilizer, is at least partially chemically produced in a pre-neutralizer and/or reactor. The fertilizer can include, but is not limited to MAP or DAP, or triple super phosphate fertilizers and combinations thereof.

More specifically, an ammonium phosphate fertilizer is produced by reacting phosphoric acid (H₃PO₄) with ammonia (NH₃) in an exothermic reaction. Monoammonium phosphate (“MAP”) or diammonium phosphate (“DAP”) can be produced according to the following reactions, depending on the ratio of the two reactants:

NH₃+H₃PO₄→(NH₄)H₂PO₄(MAP)

2NH₃+H₃PO₄→(NH₄)₂H PO₄(DAP)

In one embodiment, formulation stage 16 comprises a pre-neutralizer which is a stirred reactor that produces a slurry of ammonium phosphate from the combination of phosphoric acid (phosacid) and ammonia. For example, either MAP, DAP, or a combination thereof can be produced depending on the ratio of ammonia and phosphoric acid fed to the pre-neutralizer.

In another embodiment of the invention, formulation step 16 comprises a pipe reactor, such as a pipe cross reactor, which is a pipe-shaped reactor where ammonium phosphate is formed by reacting ammonia and phosphoric acid. As with the pre-neutralizer, either MAP and/or DAP can be produced depending on the ratio of ammonia and phosphoric acid fed to the pipe reactor.

In yet another embodiment of the invention, formulation step 16 comprises a combination of a pre-neutralizer and a pipe cross reactor (PCR), in which a portion of the ammonium phosphate fertilizer is formed in the pre-neutralizer, and another portion is formed in the pipe cross reactor, such as described in U.S. Pat. No. 7,497,891, previously incorporated into reference in its entirety.

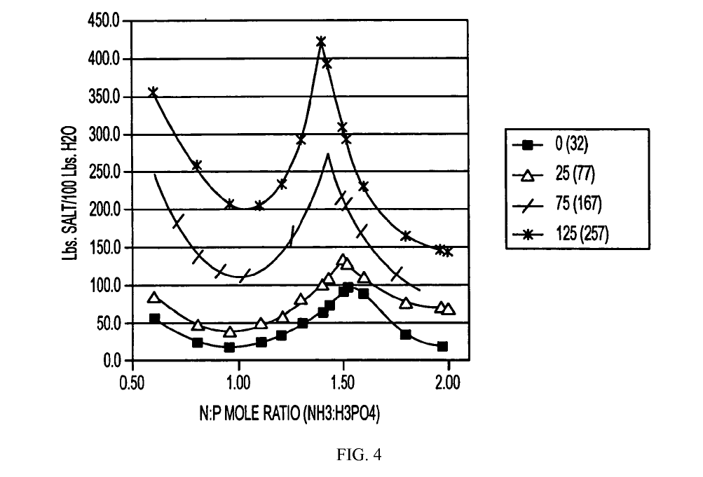

The amounts of ammonia and phosphoric acid that are fed to the various components described herein in various stages are controlled based on a solubility curve (Frank Achorn and David Saliday, “Latest Developments in use of TVA Rotary Ammonia Granulator”, AlChE Meeting, Washington, D.C., November 1983), reproduced in FIG. 4, showing the water solubility of ammonium phosphate at different temperatures for a varying molar ratio of nitrogen to phosphorous. As demonstrated in FIG. 4, there are two dips in the solubility curve, respectively at N:P ratios of 1.0 and 2.0. At these dips, very little ammonium phosphate remains in solution. The dip at 1.0 represents MAP, and the dip at 2.0 represents DAP. The curve also shows that the solubility increases with increasing temperatures.

For example, when a PCR is incorporated in the production stage 10 as described above, the PCR runs at a greatly elevated temperature. At these temperatures, the ammonium phosphate is a molten liquid, such that ammonia and phosphoric acid can be fed into the PCR at the desired ratio of ammonia to phosphoric acid (N:P) in a range of about 1.0 to 2.0.

On the other hand, the ammonium phosphate, which travels from the preneutralizer to the granulator, is at a significantly reduced temperature. The N:P mole ratio in the preneutralizer is outside of the low solubility dips, and this can help maintain the ammonium phosphate as a slurry before introduction to the granulator in granulation stage 12, described below. For example, to make MAP, the N:P ratio of reactants fed to the preneutralizer may be 0.3 to 0.9, more particularly 0.5 to 0.7, and still more particularly 0.55 to 0.65. To make DAP, the N:P ratio of reactants fed to the preneutralizer may be 1.1 to 1.7, more particularly 1.3 to 1.5, and still more particularly 1.35 to 1.45.

Referring back to FIG. 1, in one embodiment, the pre-neutralizer and/or reactor can comprise at least one feed stream 18 for supplying at least one feed ingredient, such as a phosphacid, to the pre-neutralizer and/or reactor for the formulation of the fertilizer.

In another embodiment shown in FIG. 2, the pre-neutralizer and/or reactor can further comprise a waste gas output stream 20. In this configuration, a waste gas scrubber 22 intersects waste gas output stream 20 with a water stream to generate a water return stream 24 containing dissolved un-reacted ingredients that are fed back into the pre-neutralizer and/or reactor.

As shown in FIGS. 1-2, the pre-neutralizer and/or reactor can further comprise at least one micronutrient feed stream 26. The micronutrient feed stream 26 can supply at least one micronutrient including, but not limited to boron, copper, iron, manganese, molybdenum, zinc and combinations hereof. In one particular embodiment, the one or more micronutrients are dissolved in the feed stream as a compound such as, for example, in the form of oxides, sulfides, carbonates, or sulfates, and/or hydrates thereof. These compounds can include, for example, zinc oxide (ZnO), sodium tetraborate (Na₂B₄O₇ or Na₂B₄O₇.5H₂O), or other similar compounds.

As shown in FIG. 1, in one embodiment of the present invention, the micronutrient feed stream 26 can intersect the feed stream 18 to dissolve the micronutrient in the feed stream 18 containing the raw ingredients for the primary neutralizer. As shown in FIG. 2, in another embodiment of the present invention, the micronutrient feed stream 26 can intersect the water return stream 24 to dissolve the micronutrient in the water return stream 24. The micronutrient is a non-reactant in the primary nutrient formulation reactions (i.e. base fertilizer formulation), but is distributed throughout the individual fertilizer granule. The resulting concentration of the micronutrient in the individual fertilizer granules can be varied by the adjusting the amount of micronutrients supplied through the micronutrient feed stream.

As shown in FIGS. 1-3, the granulation stage 12 can further comprise a granulation step 28 and a drying step 30. In the granulation step 28, the formulated fertilizer slurry or material is rotated in a rotating granulation drum to form a rolling bed of fertilizer granules. In one embodiment, the granulation drum can further comprise a phosacid feed stream 32 for back-titration of the fertilizer, i.e. to reduce the mole ratio of N:P.

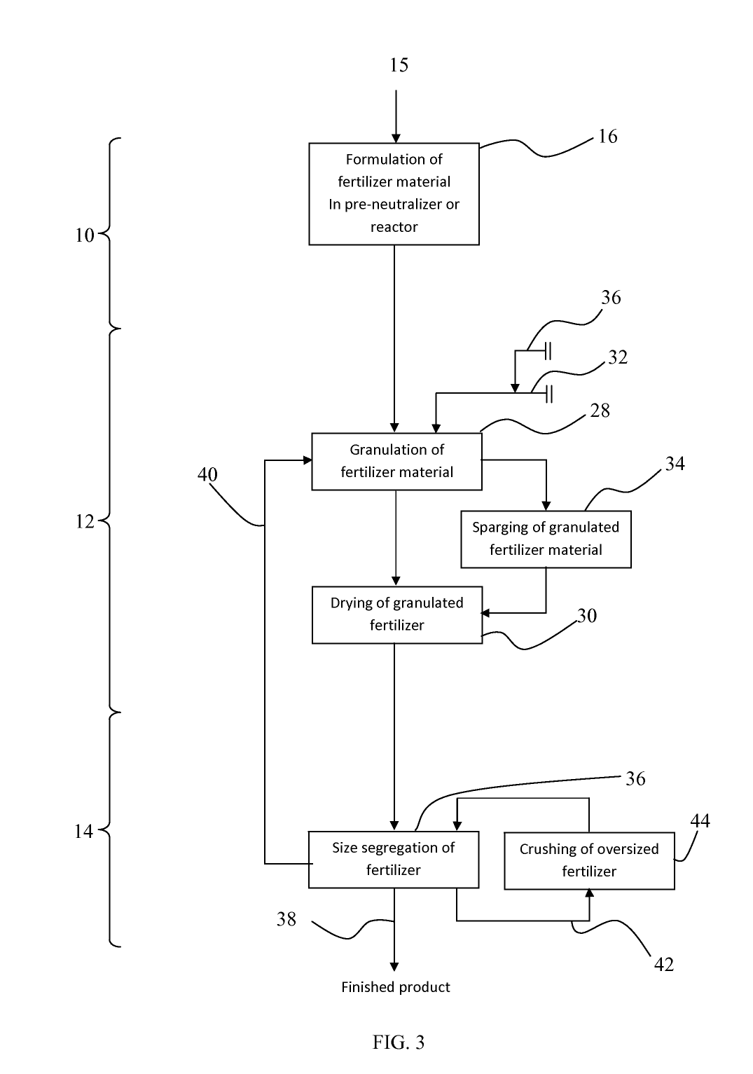

As shown in FIG. 3, the rotating granulation drum can further comprise a micronutrient feed stream 36 for supplying at least one micronutrient either directly into the granulation drum and/or to the phosacid feed stream 32 to the granulation drum. The amount of micronutrient applied to the primary nutrient can be varied by adjusting the amount of the micronutrient dissolved into the phosacid feed stream 32 and/or applied directly to the drum. In one embodiment, the micronutrient(s) is introduced into the feed stream 32 as a compound, which is then dissolved within the feed stream.

Specifically for ammonium phosphate fertilizers, the granulation stage 14 can further comprise a sparging step 34 in which the fertilizer granules are treated in an under-bed ammonia sparger to complete the ammonium phosphate reaction to form the desired ammonium phosphate fertilizer. In the drying step 30, the fertilizer granules are dried to reduce the moisture content and remove un-reacted volatiles.

Optionally, granulation stage 14 can including a source of sulfur, such as elemental sulfur or sulfate sulfur, for example, as described in U.S. Pat. No. 6,544,313 previously incorporated into reference in its entirety. The sulfur source can be applied to the granules in the granulated drum, for example, by spraying molten sulfur thereon.

As shown in FIGS. 1-3, the size segregation/correction stage 14 can further comprise a product sizing step 36 in which the granulated fertilizer is split into a plurality of streams according to particle size. In the product sizing step 36, the quantity of fertilizer granules is passed through a plurality of sizing screens to split the fertilizer granules into a correctly sized stream 38, an undersized stream 40, and an oversized stream 42. The correctly sized stream 38 comprises fertilizer granules having particle sizes between from about 2 mm to about 4 mm diameter. In one embodiment, the fertilizer granules are sized to breakdown in the soil into its constituent granules to increase surface area for interaction with the plant roots. The undersized stream 38 comprises fertilizer granules having a particle size less than 20 mesh Tyler. The fertilizer granules in the undersized stream 40 can be returned to the granulation stage 20 for additional processing. Similarly, the undersized stream 42 comprises fertilizer granules having a particle size greater than 4 mesh Tyler, which undergo a crushing step 44 to reduce the particle size to within the appropriate range.

While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

What is claimed is:

1. A method of making a granulated fertilizer having at least one primary nutrient and at least one micronutrient comprising:
supplying feed ingredients to a reactor or preneutralizer, where the feed ingredients undergo a chemical reaction to form a slurry;
removing and capturing a waste gas from the reactor or preneutralizer, wherein the waste gas includes un-reacted feed ingredients;
scrubbing the waste gas with water in a waste gas scrubber to recover a water return stream including the un-reacted feed ingredients;
adding at least one dissolved micronutrient to the water return stream;
returning the water return stream to the reactor or preneutralizer;
combining the water return stream with the slurry such that the at least one dissolved micronutrient is incorporated into the slurry; and
forming fertilizer granules from the slurry, wherein the at least one dissolved micronutrient is distributed throughout the fertilizer granules.

2. The method of claim 1, wherein forming fertilizer granules comprises:
granulating the slurry in a rotating bed granulator to form a plurality of fertilizer granules;
drying the fertilize granules; and
sorting the fertilizer granules to aggregate fertilizer granules having a commercially desirable size range.

3. The method of claim 1, further comprising:
dissolving at least one micronutrient in a feed stream to the reactor or preneutralizer, the feed stream having at least one of the feed ingredients.

4. The method of claim 1, wherein the at least one micronutrient is selected from the group comprising: boron, copper, iron, manganese, molybdenum, zinc, chlorine, cobalt, sodium and combinations thereof.

5. The method of claim 1, wherein forming the fertilizer granules further comprises:
sparging the fertilizer granules to complete the chemical reaction to form the fertilizer granules.

6. The method of claim 1, wherein the fertilizer granules have a mean particle diameter of between about 2 mm to about 4 mm.

7. The method of claim 2, wherein the step of sorting the fertilizer granules, further comprises:
aggregating undersized fertilizer granules having a particle diameter less than about 2 mm; and
supplying the undersized fertilizer granules to a granulation step.

8. The method of claim 2, wherein the step of sorting the fertilizer granules, further comprises:
aggregating oversized fertilizer granules having a particle diameter greater than about 4 mm;
crushing the oversized fertilizer granules to form a crushed granule stream; and
supplying the crushed granule stream to a sorting step.

9. The method of claim 1, further comprising:
providing a source of sulfur to the granulation drum, thereby coating the fertilizer granules with the source of sulfur.

10. The method of claim 9, wherein the source of sulfur is selected from the group consisting of elemental sulfur, sulfate sulfur, and combinations thereof.

11. A method of making a granulated fertilizer composition having at least one primary nutrient and at least one micronutrient comprising:
supplying feed ingredients to a reactor or preneutralizer, where the feed ingredients undergo a chemical reaction to form a slurry;
dissolving at least one micronutrient into a phosphoric acid stream;
adding the phosphoric acid stream to the slurry to optimize a mole ratio of the feed ingredients; and
granulating the slurry in a granulator to form fertilizer granules.

12. The method of claim 11, the method further comprising:
drying the fertilize granules; and
sorting the fertilizer granules to aggregate fertilizer granules having a commercially desirable size range.

13. The method of claim 11, wherein the at least one micronutrient is selected from the group comprising: boron, copper, iron, manganese, molybdenum, zinc, chlorine, cobalt, sodium and combinations thereof.

14. The method of claim 13, further comprising:
introducing the micro nutrient as a compound.

15. The method of claim 11, wherein the step of granulating the fertilizer to form fertilizer granules, further comprises:
sparging the fertilizer granules to complete the chemical reaction to form the fertilizer.

16. The method of claim 11, wherein fertilizer granules have a mean particle diameter of between about 2 mm to about 4 mm.

17. The method of claim 12, wherein the step of sorting the fertilizer granules, further comprises:
aggregating undersized fertilizer granules having a particle diameter less than about 2 mm; and
supplying the undersized fertilizer granules to a granulation step.

18. The method of claim 12, wherein the step of sorting the fertilizer granules, further comprises:
aggregating oversized fertilizer granules having a particle diameter greater than about 4 mm;
crushing the oversized fertilizer granules to form a crushed granule stream; and
supplying the crushed granule stream to a sorting step.

19. The method of claim 11, wherein adding the phosphoric acid stream to the slurry comprises adding the phosphoric acid stream to the slurry during granulation.

20. The method of claim 19, further comprising:
adding a second phosphoric acid stream containing one or more micronutrients dissolved therein to the preneutralizer.

21. The method of claim 20, wherein the one or more micronutrients in the second phosphoric acid stream are different than the one or more micronutrients added to the phosphoric acid stream added to the slurry during granulation.

22. The method of claim 11, wherein the feed ingredients comprise ammonia and phosphoric acid which react to form an ammonium phosphate slurry.

23. The method of claim 22, wherein the feed ingredients are fed to the reactor or preneutralizer at an N:P molar ratio of 0.3 to 0.9, thereby forming monoammonium phosphate (MAP).

24. The method of claim 22, wherein the feed ingredients are fed to the reactor or preneutralizer at an N:P molar ratio of 1.1 to 1.7, thereby forming diammonium phosphate.
